(19) United States
(12) Patent Application Publication
(10) Pub. No.: US 2026/0089104 A1
(43) Pub. Date: Mar. 26, 2026

(54) DATA PACKET ROUTING VIA MULTIPLE LOGICAL CHANNELS

(71) Applicant: Lenovo (United States) Inc., Morrisville, NC (US)

(72) Inventors: Joachim Löhr, Wiesbaden (DE); Prateek Basu Mallick, Dreieich (DE); Ravi Kuchibhotla, Chicago, IL (US)

(73) Assignee: Lenovo (United States) Inc., Morrisville, NC (US)

(21) Appl. No.: 18/891,805

(22) Filed: Sep. 20, 2024

(51) Int. Cl. H04L 47/11; H04L 45/00

(52) U.S. Cl. CPC H04L 47/115; H04L 45/26

(57) ABSTRACT

Various aspects of the present disclosure relate to data packet routing via multiple logical channels. An apparatus, such as a UE, receives signaling that indicates a radio link control (RLC) configuration for a radio bearer associated with an RLC entity. The UE establishes the RLC entity based on the RLC configuration, where the RLC entity includes multiple logical channels. The UE routes a set of data packets via the logical channels based on parameters associated with at least one of the logical channels or the set of data packets. For example, a first portion of data packets of the set of data packets is routed via a first logical channel associated with a first priority and a second portion of data packets of the set of data packets is routed via a second logical channel associated with a second priority. The second priority is higher than the first priority.

### TECHNICAL FIELD

The present disclosure relates to wireless communications, and more specifically to routing data packets for transmission.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive signaling that indicates a radio link control (RLC) configuration for a radio bearer associated with an RLC entity, where the RLC entity includes a set of logical channels and route a set of data packets via the set of logical channels based on a set of one or more parameters associated with at least one of the set of logical channels or the set of data packets.

In some implementations of the method and apparatuses described herein, the set of one or more parameters include one or more of a priority associated with respective logical channels of the set of logical channels, a remaining delay associated with the set of data packets, a priority associated with respective data packets of the set of data packets, an importance level associated with the respective data packets of the set of data packets, or a type associated with the respective data packets. Additionally, or alternatively, to route the set of data packets, the UE routes a first portion of data packets of the set of data packets via a first logical channel associated with a first priority, and routes a second portion of data packets of the set of data packets via a second logical channel associated with a second priority, where the set of logical channels includes the first logical channel and the second logical channel, and where the second priority is higher than the first priority. Additionally, or alternatively, to route the set of data packets, the UE reroutes the second portion of data packets via the second logical channel based on the set of one or more parameters satisfying at least one threshold value.

Additionally, or alternatively, to route the set of data packets, the UE routes the set of data packets via at least one of the first logical channel or the second logical channel based on the set of one or more parameters indicating for respective data packets of the set of data packets to be routed via the first logical channel or the second logical channel. Additionally, or alternatively, to route the second portion of data packets, the UE duplicates the second portion of data packets of the set of data packets, where an original version of the second portion of data packets is routed via the first logical channel and a duplicated version of the second portion of data packets is routed via the second logical channel, receives additional signaling that indicates the duplicated version of the second portion of data packets is successfully transmitted, and discards, based on the additional signaling, the original version of the second portion of data packets. Additionally, or alternatively, the UE transmits additional signaling including at least one of a buffer status report (BSR), a delay status report (DSR), or a scheduling request (SR) that indicates the second portion of data packets are available for transmission.

Additionally, or alternatively, the UE multiplexes the second portion of data packets on one or more resources associated with at least one of an uplink grant allocating the one or more resources for an uplink transmission or a configured grant (CG) allocating the one or more resources for the second logical channel. Additionally, or alternatively, the RLC configuration includes instructions for routing the set of data packets via respective logical channels of the set of logical channels based on the set of one or more parameters. Additionally, or alternatively, the UE determines to route the set of data packets via respective logical channels of the set of logical channels based on metadata associated with the set of data packets, where the metadata indicates the set of one or more parameters.

Additionally, or alternatively, the UE determines to route the set of data packets via respective logical channels of the set of logical channels based on additional signaling from a packet data convergence protocol (PDCP) entity. Additionally, or alternatively, the RLC configuration includes a prioritized bit rate value, and a bucket size duration associated with the set of logical channels. Additionally, or alternatively, the UE receives additional signaling including an uplink grant that indicates one or more resources allocated for respective logical channels of the set of logical channels. Additionally, or alternatively, to route the set of data packets, the UE routes sets of related data packets via respective logical channels of the set of logical channels. Additionally, or alternatively, the set of data packets includes a set of RLC protocol data units (PDUs).

Some implementations of the method and apparatuses described herein may further include a processor for wireless communication to receive signaling that indicates an RLC configuration for a radio bearer associated with an RLC entity, where the RLC entity includes a set of logical channels and route a set of data packets via the set of logical channels based on a set of one or more parameters associated with at least one of the set of logical channels or the set of data packets.

Some implementations of the method and apparatuses described herein may further include a method performed by a UE, the method including receiving signaling that indicates an RLC configuration for a radio bearer associated with an RLC entity, where the RLC entity includes a set of logical channels and routing a set of data packets via the set of logical channels based on a set of one or more parameters associated with at least one of the set of logical channels or the set of data packets.

Some implementations of the method and apparatuses described herein may further include a network equipment (NE) for wireless communication to transmit signaling that indicates an RLC configuration for a radio bearer associated with an RLC entity, where the RLC entity includes a set of logical channels, receive a set of data packets via the set of logical channels, where a first portion of data packets of the set of data packets is routed via a first logical channel associated with a first priority and a second portion of data packets of the set of data packets is routed via a second logical channel associated with a second priority, the set of logical channels includes the first logical channel and the second logical channel, and the second priority is set to a value indicating a higher priority than the first priority, and disable reordering of the second portion of data packets based on the second portion of data packets being routed via the second logical channel.

In some implementations of the method and apparatuses described herein, the NE processes, at a higher layer, the second portion of data packets based on the reordering of the second portion of data packets being disabled. Additionally, or alternatively, the set of data packets are routed based on a set of one or more parameters associated with at least one of the set of logical channels or the set of data packets, and where the set of one or more parameters include one or more of a priority associated with respective logical channels of the set of logical channels, a remaining delay associated with the set of data packets, a priority associated with respective data packets of the set of data packets, an importance level associated with the respective data packets of the set of data packets, or a type associated with the respective data packets. Additionally, or alternatively, the NE transmits additional signaling that indicates the second portion of data packets is successfully received.

Additionally, or alternatively, the NE receives additional signaling including at least one of a BSR, a DSR, or an SR that indicates the second portion of data packets are available for transmission. Additionally, or alternatively, the second portion of data packets is multiplexed on one or more resources associated with at least one of an uplink grant allocating the one or more resources for an uplink transmission or a CG allocating the one or more resources for the second logical channel. Additionally, or alternatively, the RLC configuration includes instructions for routing the set of data packets via respective logical channels of the set of logical channels based on parameters. Additionally, or alternatively, the RLC configuration includes a prioritized bit rate value, and a bucket size duration associated with the set of logical channels. Additionally, or alternatively, the NE transmits additional signaling including an uplink grant that indicates one or more resources allocated for respective logical channels of the set of logical channels. Additionally, or alternatively, the set of data packets includes a set of RLC PDUs.

### BRIEF DESCRIPTION OF THE DRAWINGS

FIG. 1 illustrates an example of a wireless communications system in accordance with aspects of the present disclosure.

FIGS. 2 and 3 illustrate example data packet routing diagrams, in accordance with aspects of the present disclosure.

FIG. 4 illustrates an example information element, in accordance with aspects of the present disclosure.

FIGS. 5 and 6 illustrate example data packet routing diagrams, in accordance with aspects of the present disclosure.

FIG. 7 illustrates an example signaling diagram, in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a NE in accordance with aspects of the present disclosure.

FIG. 11 illustrates a flowchart of a method performed by a UE in accordance with aspects of the present disclosure.

FIG. 12 illustrates a flowchart of a method performed by a NE in accordance with aspects of the present disclosure.

### DETAILED DESCRIPTION

One or more devices in a wireless communications system, such as UEs and NEs, may exchange signaling, including one or more data packets. The devices process the data packets prior to transmission using a set of protocols, referred to as a protocol stack. The protocol stack is organized into multiple layers with respective entities that perform corresponding functions, including, but not limited to, a physical (PHY) layer, a medium access control (MAC) layer, an RLC layer, and a PDCP layer. The devices may use one or more communication paths (e.g., logical channels) to transfer different types of information between entities of different layers in the protocol stack. The devices may determine an order in which to process data packets from different logical channels using priorities of the respective logical channels in a logical channel prioritization (LCP) procedure. However, conventional LCP procedures do not consider factors other than a priority of a logical channel, such as packet delay or application-specific criteria for data packets. Thus, a device may be unable to prioritize time critical or important data packets within a logical channel, leading to suboptimal resource allocation and degraded quality of service (QoS) for delay sensitive or content critical applications (e.g., extended reality (XR) services).

As described herein, to reduce or prevent inefficient resource allocation and degraded QoS in LCP procedures, a device (e.g., a UE or NE) may associate multiple logical channels with a single RLC entity of a radio bearer and may route data packets via the multiple logical channels of the RLC entity. An RLC entity is a functional component within the RLC layer of the protocol stack responsible for handling data transfer between the PDCP layer above the RLC layer and the MAC layer below the RLC layer. For example, a NE may transmit an RLC configuration to a UE that instructs the UE to establish an RLC entity with a first logical channel and a second logical channel with a priority higher than the first logical channel. The UE can dynamically route data packets via the first logical channel or the second logical channel according to a remaining delay for the data packets, an importance level of the data packets, a type of the data packets, or any other parameter related to the data packets or logical channels. For example, if the data packet has an importance that satisfies (e.g., is greater than or equal to) a threshold importance value, then the UE routes the data packet via the second logical channel. In some other examples, if a remaining delay of a data packet routed via the first logical channel satisfies (e.g., is less than or equal to) a threshold remaining delay value, then the UE may reroute the data packet via the second logical channel. The UE may process and transmit data packets from the second logical channel prior to data packets from the first logical channel according to the priorities of the logical channels.

Aspects of the present disclosure are described in the context of a wireless communications system and include implementations that provide improved resource allocation, QoS, and/or quality of experience (QoE) for wireless communications between devices in the wireless communications system. By associating multiple logical channels with a single RLC entity and implementing intelligent routing for data packets (e.g., using parameters and/or metadata related to the data packets), the devices can dynamically prioritize data packets within a logical channel. The dynamic prioritization of data packets reduces expiry of a remaining delay for data packets while in a logical channel, as the data packets can be rerouted via a higher priority logical channel. Additionally, or alternatively, the dynamic prioritization of data packets leads to a device processing and transmitting data packets according to an importance of the data packets by routing the data packets with an importance greater than a threshold importance value via a higher priority logical channel.

Aspects of the present disclosure are described in the context of a wireless communications system.

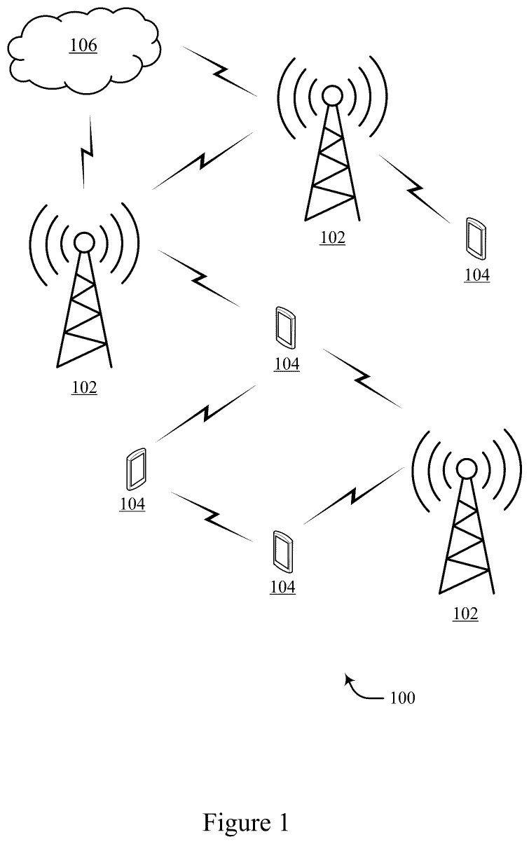

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, a NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, a NE 102 and a UE 104 may support wireless communication of signals related to services (e.g., voice, video, packet data, messaging, broadcast, etc.) according to one or multiple radio access technologies. In some implementations, a NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, a NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network (AN) entity, which may be an example of an access node controller (ANC). An ANC may communicate with the one or more UEs 104 through one or more other AN transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via a NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the devices in the wireless communications system 100 (e.g., UEs 104 and NEs 102) may transmit and receive signaling related to XR services. XR services can include a virtual reality (VR) service, which includes a rendered version of a delivered visual and audio scene. The rendering is designed to mimic the visual and audio sensory stimuli of the real world as naturally as possible to an observer or user as they move within the application. For a VR scenario, a user may wear a head mounted display (HMD) to replace a field of view of the user with a simulated visual component, and the user may wear headphones to provide the user with audio that accompanies the simulated visual component. The device may perform head and motion tracking of the user in VR to allow the simulated visual and audio components to be updated to ensure that, from the perspective of the user, items and sound sources remain consistent with the movements of the user.

Additionally, or alternatively, the XR services can include augmented reality (AR) services. AR services include when a user is provided with additional information, or artificially generated items or content overlaid upon a current environment. Such additional information or content may be visual and/or audio and an observation of a current environment may be direct, with no intermediate sensing, processing, and rendering, or indirect, where a perception of the environment is relayed via sensors and may be enhanced or processed. Additionally, or alternatively, the XR services can include mixed reality (MR) services. MR services are an advanced form of AR services, where some virtual elements are inserted into the physical scene with the intent to provide the illusion that these elements are part of the real scene. XR refers to all real-and-virtual combined environments and human-machine interactions generated by computer technology and wearables. XR includes representative forms, such as AR, MR, VR, and the areas interpolated among them. The levels of virtuality range from partially sensory inputs to fully immersive VR. A key aspect of XR is the extension of human experiences especially relating to the senses of existence (e.g., represented by VR) and the acquisition of cognition (e.g., represented by AR).

In some examples, the XR and CG use cases are characterized by quasi-periodic traffic with possible jitter and a high data rate in the downlink (e.g., video steam) combined with frequent uplink communications (e.g., pose/control update) and/or uplink video stream. Both downlink and uplink traffic are also characterized by relatively strict (e.g., less than a threshold value) packet delay budget (PDB). In some examples, additional information on the running services from higher layers of a protocol stack (the QoS flow association, frame-level QoS, PDU set-based QoS, XR specific QoS etc.), may be beneficial to facilitate informed choices of radio parameters. XR application awareness by a UE 104 and a NE 102 may improve the user experience, improve the capacity of the wireless communications system 100 in supporting XR services, and reduce the power consumption at the UE 104.

An application data unit (ADU) or PDU set is the smallest unit of data that can be processed independently by an application (e.g., processing for handling out-of-order traffic data). A video frame can be an I-frame, P-frame, or can be composed of I-slices, and/or P-slices. I-frames and/or I-slices are more important and larger than P-frames and/or P-slices. A PDU set can be one or more I-slices, P-slices, I-frame, P-frame, or any combination. A service-oriented design considering XR traffic characteristics (e.g., variable packet arrival rate: packets coming at 30-120 frames/second with some jitter, packets having variable and large packet size, B/P-frames being dependent on I-frames, presence of multiple traffic or data flows such as pose and video scene in uplink) can enable more efficient XR service delivery. More efficient XR service delivery can include satisfying XR service criteria for a greater number of UEs, or in terms of UE power saving.

In some examples, data packets may have a latency criteria, referred to as a PDB. PDB is a QoS parameter that specifies a threshold (e.g., maximum) amount of time a data packet can take to travel from a source to a destination within the network. For example, The PDB is a limited time budget for a packet to be transmitted over the air from a NE 102 to a UE 104, or vice-versa. The PDB represents an upper limit of acceptable end-to-end delay for a service or application. PDB may be measured in milliseconds (ms) and is used by the network to prioritize and schedule data packet transmissions to meet latency criteria of different services, such as voice calls, video streaming, or real-time gaming. For a given data packet, the delay of the data packet incurred in the air interface is measured from the time that the packet arrives at a device (e.g., a NE 102 or UE 104) to the time that the data packet is successfully transferred to another device (e.g., a UE 104 or a NE 102). If the delay is larger than a given PDB for the data packet, then the data packet violates the PDB, otherwise the packet is successfully delivered.

In some cases, a value of PDB may vary for different applications and traffic types, which can be 10-20 ms depending on the application. Arrival time of data bursts on the downlink (e.g., for 5G communications) can be quasi periodic or periodic with jitter. Factors leading to jitter in burst arrival include, but are not limited to, varying server render time, encoder time, real-time transport protocol (RTP) packetization time (e.g., the duration of media content encapsulated within a single RTP packet), or a link between a server and a 5G gateway, among other examples. In some examples, applications may have a delay criteria for a PDU set that may not be adequately translated into a PDB. For example, if the PDU set delay budget (PSDB) is 10 ms, then PDB can be set to 10 ms if all packets of the PDU set arrive at the same time. If the packets of the PDU are spread out, then the PSDB is measured either in terms of the arrival of the first packet of the PDU set or the last packet of the PDU set. A given PSDB results in a different PDB for different packets of the PDU set.

If the scheduler (e.g., the NE 102) and/or the UE 104 is aware of delay budgets for a packet or PDU set or ADU, then the NE 102 can schedule transmissions by giving priority to transmissions close to a delay budget limit, and by not scheduling (e.g., uplink) transmissions. Additionally, or alternatively, the UE 104 may determine if an uplink transmission (e.g., a physical uplink control channel (PUCCH) in response to a physical downlink shared channel (PDSCH), an uplink pose data including information about the position and orientation related to a user, or a physical uplink shared channel (PUSCH)) that satisfies (e.g., is greater than or equal to) a delay budget can be dropped. The UE 104 may not wait for retransmission of a PDSCH that is dropped and may not keep an erroneously received PDSCH in a buffer for soft combining with a retransmission that never occurs. The UE 104 may determine how much of a channel occupancy (e.g., when using an unlicensed spectrum) can be shared with the NE 102. The NE 102 may indicate the remaining delay budget for a downlink transmission in a downlink control information (DCI) message (e.g., for a packet of a video frame, slice, and/or ADU) or via a MAC-control element (MAC-CE) (e.g., for an ADU, video frame, and/or slice). The UE 104 may indicate the remaining delay budget for an uplink transmission via an uplink transmission, such as in an uplink control information (UCI) message, a PUSCH transmission, or any other type of uplink transmission.

In some examples, the lower layers of a protocol stack, such as RLC or PDCP layers, obtain information about the content and criteria of data packets at the lower layers, which is referred to as application awareness. For example, the lower layers can identify a type of application data (e.g., video frame, audio packet, haptic feedback) within the data packets, an importance or criticality of data packets to an overall application performance (e.g., an I-frame in a video stream), dependencies between data packets (e.g., which data packets are to be decoded first to enable decoding of subsequent packets), and application-specific criteria (e.g., delay sensitivity or synchronization for XR services). Application awareness for XR services relies on QoS flows, PDU sets, data bursts, and traffic assistance information. To enable PDU set based QoS handling, a session management function (SMF) may provide PDU set QoS parameters to the NE 102 as part of a QoS profile of a QoS flow. The PDU set QoS parameters can include, but are not limited to, a PDU PSDB, a PDU set error rate (PSER), and/or PDU set integrated handling information (PSIHI).

In some examples, a PDU PSDB is an upper bound for a duration between the reception time of a first PDU (e.g., at a user plane function (UPF) for downlink or at the UE 104 for uplink) and the time when all PDUs of a PDU set have been successfully received (e.g., at the UE 104 in downlink, at the UPF in uplink). A QoS flow is associated with one PSDB, and when available, the PSDB applies to both downlink and uplink and supersedes the PDB of the QoS flow. A PDSB of an AN (e.g., a RAN), an AN PSDB, is derived by subtracting a CN PDB from a PSDB. A PSER is an upper bound for a rate of non-congestion related PDU set losses between a NE 102 (e.g., RAN) and a UE 104. A QoS flow is associated with one PSER, and when available, the PSER applies to both downlink and uplink and supersedes the packet error rate (PER) of the QoS flow. In some cases, a PDU set is considered as successfully delivered when all PDUs of a PDU set are delivered successfully. In some examples, PSIHI indicates whether the application layer uses all PDUs of the PDU set. The PDU set QoS parameters may be common for PDU sets within a QoS flow.

The UPF may identify PDUs that belong to PDU sets and may determine PDU set information to send to the NE 102 in a general packet radio service (GPRS) tunneling protocol-user plane (GTP-U) header. The PDU set information can include, but is not limited to, a PDU set sequence number, an indication of an end PDU of the PDU set, a PDU sequence number within a PDU set, a PDU set size (e.g., in bytes), or a PDU set importance (PSI). The PSI identifies a relative importance of a PDU set compared to other PDU sets within a same QoS flow. In some cases, a 5GC provides traffic assistance information to the NE 102 via time sensitive communication assistance information (TSCAI) (e.g., for both guaranteed bit rate (GBR) and non-GBR QoS flows). The traffic assistance information can include, but is not limited to, an uplink and/or downlink periodicity, jitter information (e.g., between the UPF and data network) associated with the downlink periodicity, or an indication of an end of data burst (e.g., in the GTP-U header of the last PDU in downlink). In the uplink, the UE 104 may identify PDU sets and data bursts dynamically, including PSI.

In some examples a packet arrival rate is determined by a frame generation rate (e.g., 60 frames per second (fps)). An average packet arrival periodicity is given by the inverse of the frame rate (e.g., 16.6667 ms= 1/60 fps). A periodic arrival without jitter gives the arrival time at a NE 102 for a packet with an index k(=1,2,3, . . . ) as

$$\frac{k}{F} * 100 \; 0 ms ,$$

where F is a given frame generation rate per second. The periodic packet arrival implicitly assumes fixed delay contributed from a network side including fixed video encoding time, fixed network transfer delay, etc. However, in a real system, the varying frame encoding delay and network transfer time introduces jitter in packet arrival time at a NE 102. The jitter may be modeled as a random variable added on top of a periodic arrival. The jitter may follow a truncated Gaussian distribution with the statistical parameters shown in Table 1.

TABLE 1
Statistical parameters for jitter

| Parameter | unit | Baseline value for evaluation | Optional value for evaluation |
|---|---|---|---|
| Mean | ms | 0 | |
| Standard deviation | ms | 2 | |
| Truncation range | ms | [−4, 4] | [−5, 5] |

The given parameter values and considered frame generation rates (e.g., 60 fps or 120 fps) ensure that packet arrivals are in order (e.g., arrival time of a next packet is larger than that of the previous packet). Thus, the periodic arrival with jitter gives the arrival time for packet with index k(=1,2,3, . . . ) as

$$offset + \frac{k}{F} * 100 \; 0 + J ms ,$$

where F is the given frame generation rate per second and J is a random variable capturing jitter. Note that actual traffic arrival timing of traffic for each UE could be shifted by an arbitrary offset (e.g., offset) that is UE specific.

In some examples, overriding or adjusting a priority of a logical channel during a delay aware LCP procedure is based on a remaining time of the data of a logical channel. A UE 104 may use an additional logical channel priority configured to logical channels with delay critical data available for transmissions. For example, a UE 104 may adapt a logical channel priority based on a remaining delay (e.g., time) of data within the logical channel. The UE 104 may increase the priority of a logical channel if a remaining delay of data of the logical channel is lower than a threshold value and/or may use a second configured priority. A MAC entity may determine a logical channel priority for a logical channel for an LCP procedure by considering the remaining delay of data buffered for the logical channel before the LCP procedure is executed. Additionally, or alternatively, the MAC may determine the priority of a logical channel by considering the remaining delay of data buffered data before executing assigning uplink resources in the LCP procedure (e.g., in a priority order regardless of a bucket size duration, Bⱼ). Thus, a logical channel is not further prioritized when assigning the uplink resources if the delay critical data of a logical channel has been multiplexed in the MAC PDU.

Conventional LCP procedures include determining an order and an amount of data in which packets from different logical channels are multiplexed in a transport block (TB) and/or MAC PDU using the logical channel priority and Bⱼ. A remaining delay of a data packet is not considered when distributing uplink resources to the logical channels. For XR applications, a device (e.g., a UE 104 and/or a NE 102) may attempt to receive packets and/or PDU sets within an associated PDU set and/or packet delay budget (e.g., PSDB). Packets received beyond a PSDB are dropped. As conventional LCP procedures prioritize data of different logical channels based on the associated static logical channel priority, a UE may be unable to transmit data of a lower priority logical channel having a small remaining delay within a PDSB and/or PDB criteria if there is also data of a higher priority logical channel pending in a buffer of a UE 104 for transmission. That is, even though the higher priority data may have a larger remaining delay than the lower priority data (e.g., and hence there is sufficient time for the transmission of the data), the UE 104 may prioritize the high priority data and not assign any uplink resources to the lower priority data close to a delay boundary. If PDU set discarding is configured (e.g., via a parameter pdu-SetDiscard in control signaling), then the UE 104 may discard PDUs and/or PDU sets.

Discarding uplink transmissions that are carried out for PDUs of a PDU set due to satisfying (e.g., being greater than or equal to) a PSDB may impact the performance of the wireless communications system 100. For example, a latency of the wireless communications system 100 may increase and a throughput of the wireless communications system 100 may decrease due to the discarded packets being retransmitted, increasing overall end-to-end latency. Further, discarding PDUs and/or PDU sets leads to inefficient use of resources (e.g., time-frequency resources), as the resources used for the discarded PDUs and/or PDU sets could have been used for other data. For time sensitive applications, discarding PDUs and/or PDU sets can lead to missed deadlines and degraded QoS.

In some examples, to improve performance of the wireless communications system 100, the UE 104 may prioritize data packets of a logical channel which are important from the application perspective. Thus, the UE 104 performs the prioritization on a data packet level (e.g., data packets of a logical channel are treated differently in terms of priority and/or QoS), rather than at a logical channel level as in conventional approaches. The NE 102 (e.g., RAN) may support application awareness to improve resource utilization and to improve the QoE by prioritizing more important data packets. The NE 102 (e.g., RAN) may grant UEs 104 time and frequency resources according to radio conditions, a buffer status (e.g., delay information), and semantics and context of the data packets. For example, the NE 102 may specify for which information the resources are allocated for.

Reference is made herein to communicating data or information, such as signaling resources and/or communications that are transmitted or received between devices. It is to be appreciated that other terms may be used interchangeably with communicating, such as signaling, transmitting, receiving, outputting, forwarding, retrieving, obtaining, and so forth.

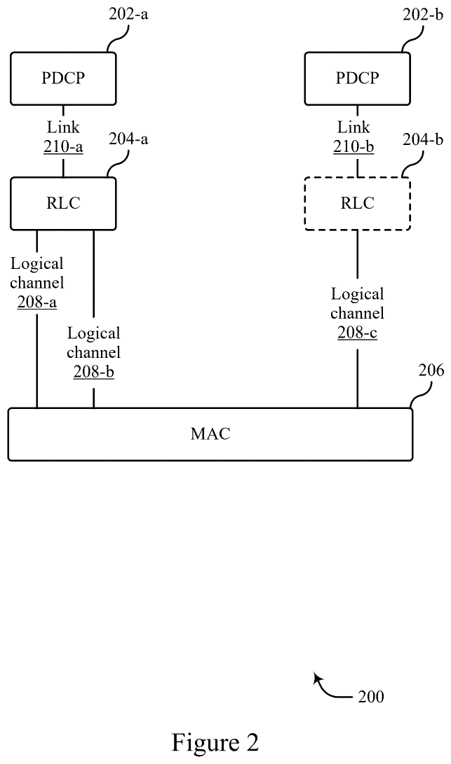

FIG. 2 illustrates an example data packet routing diagram 200 in accordance with aspects of the present disclosure. In some examples, the data packet routing diagram 200 implements or is implemented by aspects of the wireless communications system 100. The data packet routing diagram 200 may be implemented by a UE or a NE, which may be examples of a UE 104, and a NE 102 as described with reference to FIG. 1. For example, a NE may transmit an RLC configuration to indicate for the UE to establish an RLC entity of a radio bearer with multiple logical channels, and the UE may route data packets via the multiple logical channels, accordingly.

In some examples, a UE in a wireless communications system may implement a protocol stack for communicating with one or more other devices in a wireless communications system. The protocol stack may include one or more PDCP entities (e.g., the PDCP entity 202-a and the PDCP entity 202-b), one or more RLC entities (e.g., the RLC entity 204-a and the RLC entity 204-b), and a MAC entity 206. A PDCP entity processes user plane or control plane data before transmission and after reception. PDCP entities perform several important functions, including header compression and decompression, ciphering and deciphering of user and control plane data, integrity protection and verification for control plane data, in-sequence delivery and reordering of PDCP service data units (SDUs), duplicate detection and removal, PDCP SDU discard, PDCP reestablishment and data recovery for RLC acknowledge mode, and transfer of user data and control plane messages. Examples of PDCP entities include, but are not limited to, a data radio bearer PDCP entity, a signaling radio bearer PDCP entity, and a PDCP entity for split bearers in dual connectivity. A data radio bearer PDCP entity handles user plane data for a data radio bearer, performs header compression for internet protocol (IP) packets, and applies ciphering to protect user data. A signaling radio bearer PDCP entity processes control plane messages for a signaling radio bearer, applies both ciphering and integrity protection to radio resource control (RRC) messages, but does not perform header compression. A PDCP entity for split bearers in dual connectivity handles data that may be transmitted through multiple connections, performs PDCP duplication when configured, and manages potential packet reordering from multiple RLC entities. A NE may configure the PDCP entities with parameters according to criteria of the associated radio bearer and an overall network configuration.

An RLC entity operates between the PDCP and MAC layers of a protocol stack. RLC entities perform segmentation and reassembly of upper layer packets, error correction, in-sequence delivery of upper layer packets, duplicate detection, flow control, and protocol error detection and recovery. Example types of RLC entities include an RLC transparent mode entity, an RLC un-acknowledge mode entity, and an RLC acknowledge mode entity. An RLC transparent mode entity provides data transfer without adding headers. An RLC unacknowledged mode entity performs segmentation and reassembly. An RLC acknowledge mode entity ensures reliable data transfer through retransmissions and status reporting. In some examples, a NE may transmit control signaling (e.g., RRC signaling, a DCI, or a MAC-CE) that includes an RLC configuration. The RLC configuration can include one or more fields (e.g., parameters, values) that indicate for the UE to establish an RLC entity 204-a and/or an RLC entity 204-b. For example, the RLC configuration can indicate for the UE to establish an RLC entity 204-a, which includes multiple logical channels (e.g., the logical channel 208-a and the logical channel 208-b), and/or an RLC entity 204-b, which includes a single logical channel (e.g., the logical channel 208-c).

The logical channel 208-a, the logical channel 208-b, and the logical channel 208-c may provide a communication path between the RLC entity 204-a, the RLC entity 204-b, and the MAC entity 206. A MAC entity 206 manages access to shared resources (e.g., time-frequency resources). The MAC entity 206 multiplexes and demultiplexes RLC PDUs, schedules uplink and downlink transmissions, performs priority handling between logical channels, performs error correction through hybrid automatic repeat request (HARQ) feedback, and performs measurement reporting. The MAC entity 206 also handles random access procedures, maintains uplink timing synchronization, and performs transport format selection. In some examples, the MAC entity 206 may include a UE MAC entity, which resides at a UE and manages uplink transmissions, handling tasks such as BSR transmission and power headroom report (PHR) transmission. In some other examples, the MAC entity 206 may be a NE MAC, which resides at a base station or other NE and is responsible for downlink scheduling decisions, uplink grant allocations, and coordinating transmissions across multiple UEs. The MAC entity 206 interacts with multiple RLC entities (e.g., the RLC entity 204-a and the RLC entity 204-b) and the PHY layer.

In some examples, the RLC configuration may indicate for a UE to establish an RLC entity 204-a with multiple logical channels (e.g., the logical channel 208-a and the logical channel 208-b). In some cases, respective logical channels may be configured with separate parameters, such as priorities. Logical channels are used to transfer data (e.g., RLC PDUs) between an RLC entity and the MAC layer (e.g., the MAC entity 206). For an uplink scheduling procedure (e.g., an LCP procedure), the logical channels and corresponding configurations (e.g., logical channel priority, prioritizedBitRate, and bucketSizeDuration) can be used to determine an allocation of uplink resources among the data available for transmission at the UE. An RLC entity may be configured with two logical channels, including a logical channel 208-a and the logical channel 208-b. The logical channel 208-a is configured according to the QoS requirements of the corresponding data and/or service of the radio bearer. The logical channel 208-a may be referred to as a logical channel base or a primary logical channel). The logical channel 208-b is configured with a higher logical channel priority than the priority of the logical channel 208-a. The logical channel 208-b may be referred to as a logical channel boost or a secondary logical channel.

In some examples, the RLC entity 204-a maps RLC PDUs that are to be prioritized during LCP (e.g., an RLC PDU that includes delay critical data) onto the logical channel 208-b (e.g., the logical channel boost), which has a higher logical channel priority. The mapping and/or remapping of data packets or RLC PDUs from a logical channel to another logical channel can be done dynamically (e.g., on the fly, in real-time). For example, a UE may map or remap data packets before performing an LCP procedure. In some cases, the UE initially maps (e.g., routes) RLC PDUs to the logical channel 208-a (e.g., logical channel base). If the UE detects a trigger event for remapping (e.g., rerouting) one or more RLC PDUs, then the UE may remap (e.g., transfer) those RLC PDUs to the logical channel 208-b with a higher priority. The trigger event can include, but is not limited to, a remaining delay satisfying (e.g., being less than or equal to) a threshold value, a synchronization threshold expiry nearing, or any other event. Because the UE multiplexes data of a higher priority logical channel into a TB first during LCP, the usage of multiple logical channels by an RLC entity 204-a enables the prioritization of data packets within a logical channel (e.g., prioritization on a per-packet or PDU level). Using a single RLC entity 204-a with multiple logical channels provides for a UE to use a conventional LCP procedure, thereby avoiding an increase of the UE complexity.

In some cases, the UE routes the RLC PDUs to the different logical channels when generating the RLC PDUs. The UE may evaluate one or more parameters (e.g., attributes, labels) assigned to the RLC PDU and/or to respective RLC SDUs within the RLC PDU to determine a routing of the RLC PDU via the logical channels (e.g., the logical channel 208-a or the logical channel 208-b). For example, a radio bearer and correspondingly the RLC bearer may carry data of different importance or different types of data, which is of a different relevance to the application. Using the example of XR services, a radio bearer may carry PDU sets associated with a different importance level (e.g., PDU sets carrying (part of) an I-frame and PDU sets carrying B-frames or P-frames).

The NE may configure one or more logical channels for an RLC bearer. For example, the NE may use an information element (IE) (e.g., RLC-BearerConfig) to configure an RLC entity, a corresponding logical channel at a MAC entity 206, and a link to a PDCP entity 202-a (e.g., a served radio bearer). The NE may configure the link 210-a between the PDCP entity 202-a and the RLC entity 204-a. Additionally, or alternatively, the NE may configure the link 210-b between the PDCP entity 202-b and the RLC entity 204-b. The RLC-BearerConfig IE may support the configuration of multiple logical channels for an RLC entity (e.g., the RLC entity 204-a). A radio bearer is a logical connection established between RLC entities (e.g., at a UE) and other devices (e.g., a NE) for the purpose of transporting data over a radio interface. For example, radio bearers are used to carry user plane or control plane data between the UE and the NE. Radio bearers provide a means of differentiating and handling different types of traffic with varying QoS. For RLC, a radio bearer may correspond to an RLC entity. The radio bearer configuration includes parameters that define how the RLC layer processes and manages data, such as segmentation and reassembly settings, reordering timers, and status reporting mechanisms.

In some cases, an RLC entity 204-a and/or a transmitter side of an RLC entity duplicates RLC PDUs, which are to be prioritized during LCP. The RLC entity 204-a maps the duplicates to a secondary logical channel (e.g., the logical channel 208-b) configured with a higher priority. On the receiving side of an RLC entity, duplicated RLC PDUs are discarded (e.g., duplicate discarding functionality is supported at the RLC receiver). On the transmitter side, the RLC entity 204-a may discard RLC PDUs from a logical channel if a same RLC PDU is successfully transmitted on another logical channel of the RLC entity 204-a. The determination of whether an RLC PDU is successfully transmitted may be performed (e.g., by a transmitting device) based on feedback (e.g., HARQ feedback or an RLC status report).

In some examples, although the RLC entity 204-a is illustrated as including two logical channels, the RLC entity 204-a may include any numerical quantity of logical channels. Respective logical channels may be assigned different priorities (e.g., a priority with an integer value). Similarly, although the data packet routing diagram 200 is illustrated as including two RLC entities, the data packet routing diagram 200 may include any numerical quantity of RLC entities. A UE and/or a NE may implement multiple RLC entities concurrently. In some examples, the RLC configuration may include an indication of how many RLC entities the UE is to establish, as well as a numerical quantity of logical channels to establish for the respective RLC entities. In some other examples, the UE may determine how many RLC entities and logical channels to establish according to one or more parameters (e.g., attributes, labels) assigned to the data packets. For example, the parameters may include a type of the data packets, an importance of the data packets, a priority of the data packets, or any other parameters.

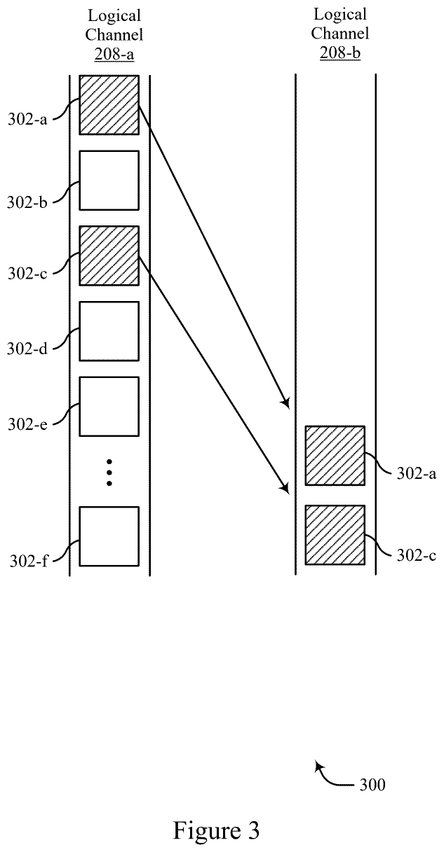

FIG. 3 illustrates an example data packet routing diagram 300 in accordance with aspects of the present disclosure. In some examples, the data packet routing diagram 300 implements or is implemented by aspects of the wireless communications system 100 and the data packet routing diagram 200. The data packet routing diagram 300 may be implemented by a UE or a NE, which may be examples of a UE 104, and a NE 102 as described with reference to FIG. 1. For example, a NE may transmit an RLC configuration to indicate for the UE to establish an RLC entity with multiple logical channels, and the UE may route data packets via the multiple logical channels, accordingly. The data packet routing diagram 200 may include a logical channel 208-a and a logical channel 208-b, which may be examples of the corresponding logical channels, as described with reference to FIG. 2.

In some examples, a UE may receive an RLC configuration indicating for the UE to establish an RLC entity with the logical channel 208-a and the logical channel 208-b. The UE may route data packets (e.g., the data packet 302-a through the data packet 302-f) via the logical channel 208-a and/or the logical channel 208-b. The data packet 302-a through the data packet 302-f may be examples of RLC PDUs. An RLC PDU is a formatted data unit processed and transmitted by the RLC layer. A UE or a NE may create RLC PDUs from RLC SDUs received from an upper layer (e.g., a PDCP entity, as described with reference to FIG. 2). The structure and content of an RLC PDU depends on an operational mode of an RLC entity (e.g., transparent mode, unacknowledged mode, or acknowledged mode). In some cases, an RLC PDU includes a header and a payload. The header includes control information, such as sequence numbers, segmentation indicators, and other fields, while the payload includes data.

In some cases, a UE may initially route the data packet 302-a through the data packets 302-f via a logical channel 208-a, where the logical channel 208-a has a lower priority than the logical channel 208-b. The UE processes the data packets from higher priority logical channels before processing data packets from the lower priority logical channels. In some examples, the UE may monitor the data packets that are routed via the logical channel 208-a (e.g., the data packets 302-a through data packets 302-f) to determine whether to reroute (e.g., transfer, remap) the data packets to a higher priority logical channel. If a remaining delay of a data packet, such as the data packet 302-a and the data packet 302-c, dops below a threshold value, then the UE may reroute the data packet 302-a and the data packet 302-c via the logical channel 208-b.

In some other cases, a UE may route the data packet 302-a through the data packet 302-f via one of the logical channel 208-a or the logical channel 208-b when generating the data packet 302-a through the data packet 302-f (e.g., using parameters of the data packets, including an importance of the data packets, a type of the data packets, or a priority of the data packets). For example, the UE may route the data packet 302-a and the data packet 302-c via the logical channel 208-b and the remaining data packets via the logical channel 208-a if the data packet 302-a and the data packet 302-c have a greater importance, a defined type, or a higher priority.

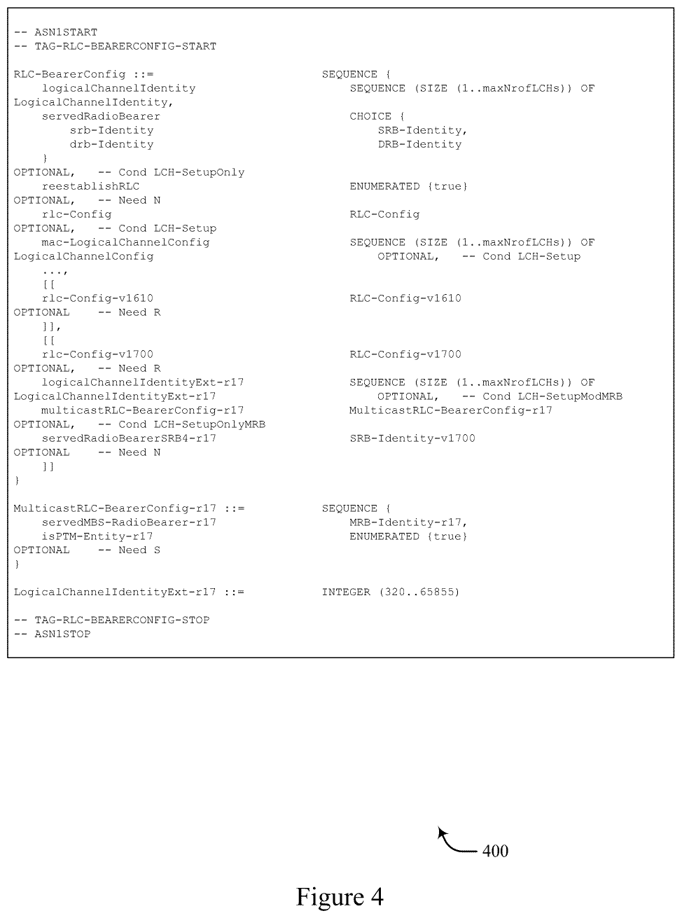

FIG. 4 illustrates an example information element 400 in accordance with aspects of the present disclosure. In some examples, the information element 400 implements or is implemented by aspects of the wireless communications system 100, the data packet routing diagram 200, and the data packet routing diagram 300. The information element 400 may be implemented by a UE or a NE, which may be examples of a UE 104, and a NE 102 as described with reference to FIG. 1. For example, a NE may transmit an RLC configuration including the information element 400 to indicate for the UE to establish an RLC entity with multiple logical channels, and the UE may route data packets via the multiple logical channels, accordingly.

In some examples, a NE may transmit control signaling (e.g., RRC signaling, a MAC-CE, or a DCI) that includes an RLC configuration for establishing an RLC entity with multiple logical channels. For example, the NE may broadcast the control signaling to multiple UEs and/or may transmit the control signaling to a single UE. The control signaling may include the information element 400. The information element 400 may be an example of a structured data field that carries configuration parameters, control information, or data within messages. The information element 400 may have a format that includes a type identifier, length indicator, and content. For example, the information element 400 may include one or more parameters (e.g., fields, values) that indicate a numerical quantity of logical channels to configure per RLC entity, among other parameters. The information element 400 may include additional, or alternative, fields to those illustrated in the information element 400.

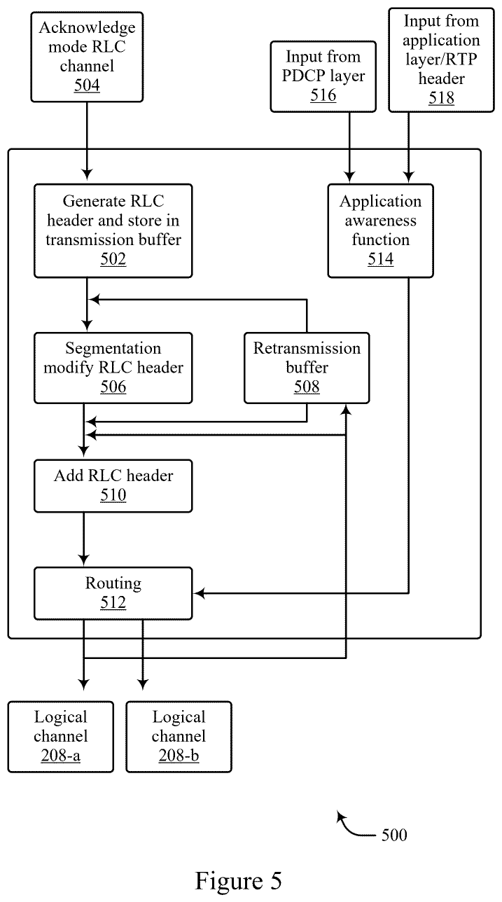

FIG. 5 illustrates an example data packet routing diagram 500 in accordance with aspects of the present disclosure. In some examples, the data packet routing diagram 500 implements or is implemented by aspects of the wireless communications system 100, the data packet routing diagram 200, the data packet routing diagram 300, and the information element 400. The data packet routing diagram 500 may be implemented by a UE or a NE, which may be examples of a UE 104, and a NE 102 as described with reference to FIG. 1. For example, a NE may transmit an RLC configuration to indicate for the UE to establish an RLC entity with multiple logical channels, and the UE may route data packets via the multiple logical channels, accordingly. The data packet routing diagram 500 may include a logical channel 208-a and a logical channel 208-b, which may be examples of the corresponding logical channels, as described with reference to FIGS. 2 and 3.

In some examples, the data packet routing diagram 500 illustrates an example of a protocol for an RLC entity at a transmitter (e.g., a UE for uplink transmissions or a NE for downlink transmissions). At 502, the RLC entity uses an acknowledge mode RLC channel 504 to generate an RLC header and store the header in a transmission buffer. At 506, the RLC entity performs segmentation to modify the RLC header. At 508, the RLC entity access the retransmission buffer (e.g., to obtain the header for the segmentation at 506, or to store the modified RLC header). At 510, the RLC entity adds the RLC header to a data packet. At 512, the RLC entity routes the data packet via one of the logical channel 208-a or the logical channel 208-b, as described with reference to FIGS. 1 through 4. It should be noted that the routing functionality as illustrated in the data packet routing diagram 500 is not limited to the acknowledge mode, but equally applicable to other RLC modes, including an RLC unacknowledged mode.

To route the data packets, the RLC entity may apply an application awareness function 514. The application awareness function 514 enables the RLC entity to recognize types of data, such as video frames, audio streams, or other application-specific data, and to understand a relative importance or time sensitivity of the data packets. The application awareness function can be implemented through various means, such as inspecting packet headers, applying defined rules from an SMF, or utilizing application programming interfaces (APIs). In some cases, the application awareness function 514 obtains input from the PDCP layer 516 and/or input from the application layer/RTP header 518.

In some cases, the RLC layer supports a routing function which maps RLC PDUs and/or SDUs to the one or more logical channels associated with the RLC entity. The RLC transmitting entity routes the generated RLC PDUs to the corresponding logical channels based on certain criteria. The criteria may include defined (e.g., preconfigured) rules. For example, the RLC entity is configured by a NE, such as an SMF, with rules for the prioritization of PDUs. Additionally, or alternatively, the RLC entity supports the application awareness function 514, which is responsible for the prioritization of RLC PDUs. The application awareness function 514 serves as an input to a routing function within the RLC entity. In some cases, the application awareness function 514 determines which RLC PDUs to prioritize and maps them to the logical channel 208-a or the logical channel 208-b, accordingly. The determination may be based on the content of the data packet contained within the RLC PDU. The application awareness function may inspect metadata of a data packet to determine an importance of an RLC PDU. For an uplink transmission, the SMF may configure a UE to inspect encapsulated metadata received in a user-plane at a layer 2 (L2) ingest reference point on the uplink based on the encapsulation protocol, QoS rules, and media components description associated with an access function session. The UE may use the SMF configuration to process the encapsulated metadata and perform the corresponding procedures and/or functions of an asynchronous transfer mode (ATM) adaptation layer (AAL) (e.g., identification of DUs and prioritization of high importance DUs).

In some cases, the UE exposes programmatic interfaces (e.g., APIs via operating system (OS) libraries or service-based interfaces through a media session handler or alternative session handler entity) to applications or other entities under the control of application service providers (ASPs). The applications configure the UE with QoS requirements for the session and the UE modem determines the QoS rules associated with the required QoS for the session. Additionally, or alternatively, the configuration may include packet detection rules and or protocol description IEs detailing the content delivery protocols employed by the application in uplink and applicable packet detection filters the UE may apply for appropriate filtering of content and a mapping to network QoS flows and lower layers radio bearers. The service-based interfaces at the UE (e.g., the interfaces exposed by a media session handler or a session handler) may be used by other network functions (e.g., an access function under the control of an ASP) to provision the UE with the packet detection rules and protocol description for uplink traffic.

In some examples, the UE may access service-based interfaces exposed by other network functions under the control of an ASP (e.g., an access function), to fetch a session configuration for the content delivery in uplink. The configuration may include the associated packet detection rules and protocol description set by an ASP for uplink traffic. Additionally, or alternatively, the PDCP layer may signal to the RLC routing function to prioritize one or more RLC PDUs, such as for cases when the associated PDCP SDU is becoming delay critical.

In some cases, the sequence numbers are assigned before the routing to the different logical channels is performed (e.g., RLC PDUs are routed to the different logical channels). There may be one common transmission and/or retransmission buffer even though the RLC entity may be associated with multiple logical channels. In some examples, an RLC and/or PDCP receiving entity may be aware that PDUs received on the logical channel 208-b are higher importance than the PDUs on the logical channel 208-a. The PDCP receiving entity may account for the higher importance of the PDUs for an optimized receiving and/or reordering window operation. For example, the PDCP receiving entity (e.g., at a NE for uplink transmission) may disable reordering for the PDUs received via the logical channel 208-b, such that high importance PDUs and/or SDUs are delivered to a higher layer (e.g., PDCP reception window) without waiting for the reordering to be finalized. For example, the NE may not wait for an expiry of a reordering timer, t-reordering.

In some examples, additional sequence numbering is performed for a secondary logical channel. When RLC PDUs are rerouted to a secondary logical channel, an additional SN is added in the RLC header of the RLC PDU. This additional sequence number enables a receiving entity (e.g., an RLC receiving entity) to identify the order of RLC PDUs being transmitted via a secondary logical channel. In some examples, the RLC header is different for RLC PDUs transmitted via the primary logical channel than for RLC PDUs transmitted via a secondary logical channel.

In some examples, a new RLC control PDU indicates to the receiving RLC entity the sequence number of the RLC PDUs rerouted via a secondary logical channel. This RLC control PDU may be sent from the transmitting entity to the receiving entity via a high priority secondary logical channel.

In some examples, such as for BSR triggering, the MAC entity considers the remapping of RLC PDUs into another logical channel as if the corresponding RLC PDUs and/or uplink data becomes available to the MAC entity (e.g., the uplink data of a logical channel arrived in the corresponding PDCP entity). For example, if a BSR triggering condition has been satisfied, then the UE determines whether the RLC PDUs are remapped from one logical channel to another logical channel (e.g., for cases when the other logical channel is of higher priority). Considering the prioritized remapped RLC PDUs as data available to the MAC entity ensures that a BSR is triggered if the remapped data belongs to a logical channel with higher priority than the priority of any logical channel containing available uplink data (e.g., belonging to any logical channel group (LGC)). The data mapped to the logical channels of an RLC entity other than the primary logical channel (e.g., data available for transmission for the purpose of BSR reporting) is reported separately in a BSR. In some cases, a new BSR MAC-CE format is introduced that indicates the amount of prioritized data available for transmission in a separate buffer size field.

In some cases, an RRC layer may control the scheduling of uplink data by generating and transmitting signaling for an RLC entity that includes token bucket related configurations. For example, the RRC layer may configure a prioritizedBitRate parameter and a bucketSizeDuration parameter for an RLC entity with multiple logical channels. Thus, the traffic shaping by means of a token bucket model is implemented per RLC entity across multiple logical channels. A bucket size, Bⱼ, is maintained per RLC entity for cases that the RLC entity is associated with multiple logical channels, where j represents a specific RLC entity index. Bⱼ defines a maximum amount of data (e.g., in bytes) that can be allocated to a set of logical channels (e.g., in the case that RLC entity is associated with multiple logical channels) during a single LCP procedure execution.

In some examples, a UE can multiplex data of a logical channel other than the primary logical channel (e.g., logical channel 208-a) into a TB regardless of the Bⱼ value for the corresponding RLC entity and/or logical channel. Thus, the prioritized RLC PDUs are multiplexed as soon as possible into allocated uplink resources. In some cases, the UE may multiplex data on a logical channel used for prioritized data (e.g., data mapped to the logical channel 208-b) using resources from any uplink grant. That is, there may not be a logical channel restriction applied for the logical channels other than the primary logical channel (e.g., logical channel 208-a) for the case that an RLC entity has multiple logical channels. In some other cases, logical channel restrictions may be configured for the additional (e.g., secondary) logical channels, including the logical channel 208-b. For example, the NE may configure one or more CG resources that are reserved for the secondary logical channels with higher priority. The NE may include the configured CG resources (e.g., time-frequency resources) in a list of allowed CG configurations.

The NE may indicate whether uplink resources are exclusively allocated for data which is mapped to a prioritized logical channel (e.g., logical channel 208-b) within an uplink grant and/or DCI. For example, a field within the uplink DCI (e.g., DCI format 0_1) scheduling a PUSCH transmission indicates whether the MAC entity or UE should apply an enhanced LCP procedure (e.g., considering only the prioritized or secondary logical channels) for the corresponding PUSCH transmission. Additionally, or alternatively, a new field or new DCI format is introduced that indicates the usage of an enhanced LCP procedure. Additionally, or alternatively, a field set to a defined value, or a combination of existing fields set to defined values or codepoints indicate for the UE to apply an enhanced LCP procedure. Additionally, or alternatively, an uplink DCI addressed to a defined RNTI (e.g., different than a C-RNTI) is used to indicate for the UE to use an enhanced LCP procedure. The new RNTI (e.g., a D-RNTI), is allocated by the NE to the UE by means of an RRC configuration.

A UE and/or MAC entity may trigger a DSR if RLC PDUs and/or uplink data are remapped or remapped to a higher priority logical channel (e.g., the logical channel 208-b) of an RLC entity, where the RLC entity has multiple logical channels. For example, when a remapping of uplink data to a logical channel different from the primary logical channel is performed, the UE or the MAC entity triggers a DSR to inform the NE of the uplink data that is to be prioritized. In some cases, the UE triggers a BSR for cases when data is mapped or remapped to another logical channel of an RLC entity. The DSR may include buffer size information for the mapped or remapped data (e.g., a total amount of data which is mapped or remapped to another logical channel of an RLC entity).

Additionally, or alternatively, a separate SR configuration is linked to secondary logical channels (e.g., the logical channel 208-b) configured for the high priority or greater importance data. To inform the NE of the high priority data available for transmission, the UE and/or the RLC entity may use a different SR configuration for the secondary logical channels of the RLC entity. In some other examples, the logical channels associated with an RLC entity use a same SR configuration (e.g., one SR configuration is used for all logical channels associated with an RLC entity).

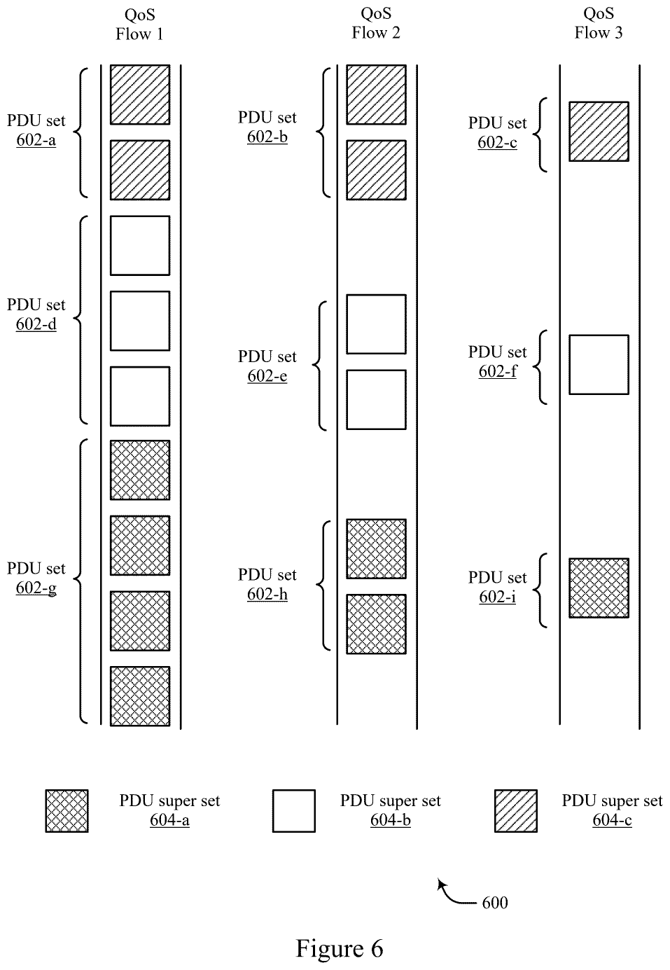

FIG. 6 illustrates an example data packet routing diagram 600 in accordance with aspects of the present disclosure. In some examples, the data packet routing diagram 600 implements or is implemented by aspects of the wireless communications system 100, the data packet routing diagram 200, the data packet routing diagram 300, the information element 400, and the data packet routing diagram 500. The data packet routing diagram 600 may be implemented by a UE or a NE, which may be examples of a UE 104, and a NE 102 as described with reference to FIG. 1. For example, a NE may transmit an RLC configuration to indicate for the UE to establish an RLC entity with multiple logical channels, and the UE may route data packets via the multiple logical channels, accordingly.

In some examples, data packets (e.g., PDUs) from different QoS flows or radio bearer that are inter-related are mapped to one logical channel. For example, PDUs in a PDU set 602-a from QoS flow 1, PDUs in a PDU set 602-b from QoS flow 2, and PDUs in a PDU set 602-c from QoS flow 3 may be mapped to a first logical channel. PDUs in a PDU set 602-d from QoS flow 1, PDUs in a PDU set 602-e from QoS flow 2, and PDUs in a PDU set 602-f from QoS flow 3 may be also mapped to the first logical channel or alternatively to a second logical channel. PDUs in a PDU set 602-g from QoS flow 1, PDUs in a PDU set 602-h from QoS flow 2, and PDUs in a PDU set 602-i from QoS flow 3 may be mapped to the first logical channel or alternatively to a third logical channel. A PDU superset may include multiple PDU sets of different QoS flows or radio bearer that are interdependent or interrelated (e.g., a PDU set of audio, a PDU set of video, and a PDU set of haptic flows for XR communications). For example, the PDU set 602-a, the PDU set 602-b, and the PDU set 602-c belong to PDU super set 604-a. The PDU set 602-d, the PDU set 602-e, and the PDU set 602-f belong to PDU super set 604-b. The PDU set 602-g, the PDU set 602-h, and the PDU set 602-i belong to PDU super set 604-c.

In some cases, for multi-modal XR applications transmitted via a wireless communications system (e.g., an NR wireless communications system), the interactions between different input signals can be translated to interdependencies between transmissions of different QoS flows, radio bearers, and/or logical channels. Due to the separate handling of the multiple media components, between different media components are synchronized to reduce or prevent negative impact on user experience. As an asynchrony between different modalities increases, a sense of presence and realism for a user decreases. Table 2 depicts synchronization thresholds between two or more modalities.

TABLE 2
Example synchronization thresholds for
immersive multi-modal VR applications

Synchronization threshold (note 1)

| | | |
|---|---|---|
| audio-tactile | audio delay: | tactile delay: |
| | 50 ms | 25 ms |
| visual-tactile | visual delay: | tactile delay: |
| | 15 ms | 50 ms |

NOTE 1:
For each media component, “delay” refers to the case where that media component is delayed compared to the other.

For example, for VR applications with visual-tactile synchronization, the visual media component may not be delayed for more than 15 ms when comparing to the tactile media component. The PDUs belonging to a PDU superset may be mapped to a single logical channel. Data (e.g., RLC PDUs) from different RLC entities (e.g., each RLC entity being associated with a different radio bearer) is mapped to one common logical channel.

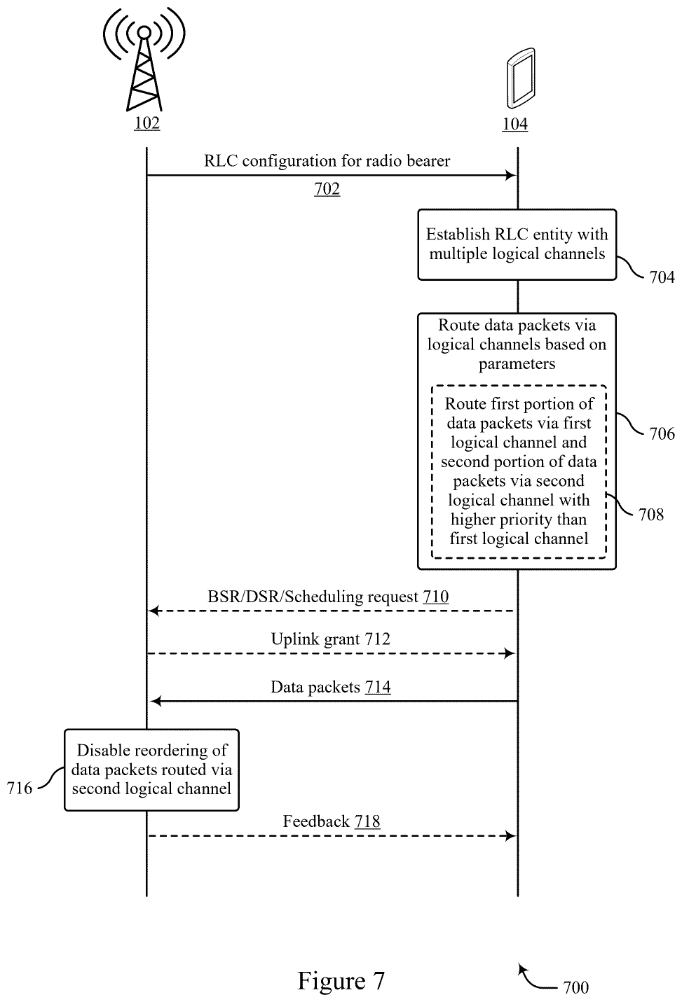

FIG. 7 illustrates an example signaling diagram 700 in accordance with aspects of the present disclosure. In some examples, the signaling diagram 700 may implement aspects of the wireless communications system 100, the data packet routing diagram 200, the data packet routing diagram 300, the information element 400, the data packet routing diagram 500, and the data packet routing diagram 600. For example, the signaling diagram 700 may be implemented by a UE 104 or a NE 102, which may be examples of a UE 104, and a NE 102 as described with reference to FIG. 1. For example, a NE 102 may transmit an RLC configuration to indicate for the UE 104 to establish an RLC entity with multiple logical channels, and the UE 104 may route data packets via the multiple logical channels, accordingly. Alternative examples of the following may be implemented, where some processes are performed in a different order than described or are not performed. In some cases, processes may include additional features not mentioned below, or further processes may be added.

At 702, the UE 104 may receive signaling from the NE 102 that indicates an RLC configuration for a radio bearer associated with an RLC entity (e.g., of the UE 104). For example, the RLC configuration may indicate for the UE 104 to establish an RLC entity with multiple logical channels. The RLC configuration may include instructions for routing the data packets via respective logical channels using one or more parameters. Additionally, or alternatively, the RLC configuration includes a prioritized bit rate value and a bucket size duration for the logical channels (e.g., with values shared across logical channels or different for respective logical channels).

At 704, the UE 104 may establish the RLC entity with multiple logical channels. For example, the UE 104 may use the RLC configuration (e.g., one or more fields or parameters in the RLC configuration) to establish the RLC entity with the multiple logical channels.

At 706, the UE 104 may route data packets via the logical channels based on the parameters. The parameters may be parameters related to the logical channels and/or the data packets. For example, the parameters may include one or more of a priority of respective logical channels, a remaining delay of the data packets, a priority of respective data packets, an importance level of the respective data packets, or a type of the respective data packets. The data packets may be examples of RLC PDUs.

For example, at 708, the UE 104 may route a first portion of data packets via a first logical channel (e.g., a primary logical channel) and a second portion of data packets via one or more second logical channels (e.g., secondary logical channels) with higher priority than the first logical channel. In some cases, the UE 104 may initially route the data packets via the first logical channel and then may reroute the second portion of data packets via the second logical channel if the parameters satisfy at least one threshold value. For example, the UE 104 may monitor the data packets routed via the first logical channel, and if a remaining delay of a data packet satisfies (e.g., is less than or equal to) a threshold value, then the UE 104 may reroute the data packet via the second logical channel. In some other cases, the UE 104 may route the data packets via at least one of the first logical channel or the second logical channel when generating the data packets. The UE 104 may route the data packets by evaluating the parameters (e.g., attributes, labels) assigned to the data packets.

In some examples, when the UE 104 routes the second portion of data packets via the second logical channel, the UE 104 duplicates the second portion of data packets. An original version of the second portion of data packets is routed via the first logical channel and a duplicated version of the second portion of data packets is routed via the second logical channel.

In some cases, the UE 104 determines to route the data packets via respective logical channels by evaluating metadata of the data packets. The metadata may indicate the parameters. Additionally, or alternatively, the UE 104 may determine to route the data packets via respective logical channels using instructions obtained from a PDCP entity. In some examples, the UE 104 may route sets of related data packets via respective logical channels.

In some cases, at 710, the UE 104 may transmit additional signaling including at least one of a BSR, a DSR, or an SR that indicates the second portion of data packets are available for transmission.

In some examples, at 712, the NE 102 may transmit an uplink grant to the UE 104 in response to the BSR, the DSR, or the SR. For example, the UE 104 may receive additional signaling that includes an uplink grant indicating one or more resources (e.g., time-frequency resources) allocated for respective logical channels.

At 714, the UE 104 may transmit the data packets to the NE 102. For example, the UE 104 may multiplex the second portion of data packets on one or more resources from at least one of an uplink grant allocating the one or more resources for an uplink transmission or a CG allocating the one or more resources for the second logical channel.

At 716, the NE 102 may disable reordering of data packets routed via the second logical channel. For example, the NE 102 may disable reordering of the second portion of data packets. The NE 102 may process, at a higher layer, the second portion of data packets without reordering the data packets.

In some cases, at 718, the UE 104 receives feedback from the NE 102. The feedback (e.g., HARQ feedback) indicates that the second portion of data packets is successfully transmitted by the UE 104 (e.g., and successfully received by the NE 102). In some cases, the second portion of data packets transmitted via the second logical channel includes the duplicated version of the second portion of data packets. Thus, the UE 104 may discard the original version of the second portion of data packets if the feedback indicates the duplicated version of the second portion of data packets is successfully received and/or transmitted.

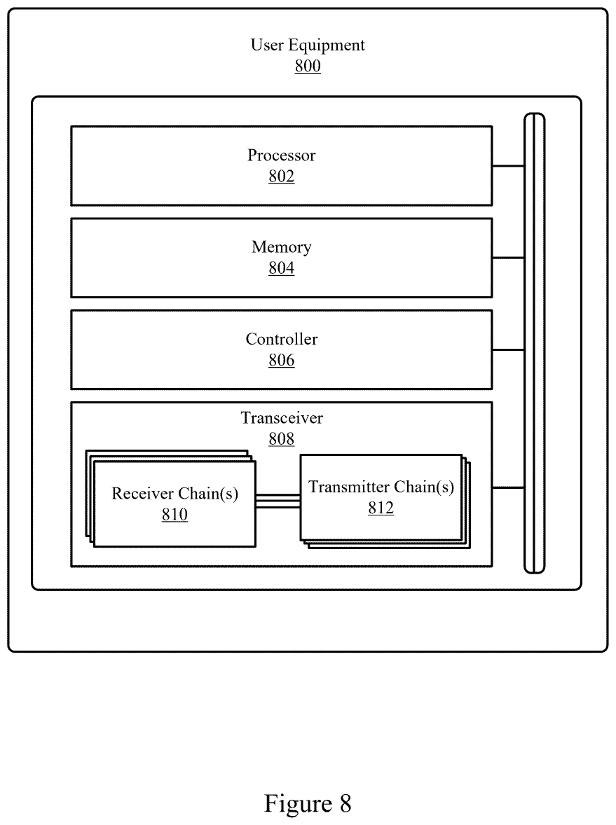

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for receiving signaling that indicates an RLC configuration for a radio bearer associated with an RLC entity, where the RLC entity includes a set of logical channels and routing a set of data packets via the set of logical channels based on a set of one or more parameters associated with at least one of the set of logical channels or the set of data packets.

Additionally, the UE 800 may be configured to support any one or combination of the set of one or more parameters include one or more of a priority associated with respective logical channels of the set of logical channels, a remaining delay associated with the set of data packets, a priority associated with respective data packets of the set of data packets, an importance level associated with the respective data packets of the set of data packets, or a type associated with the respective data packets. Additionally, or alternatively, to route the set of data packets, the UE 800 may be configured to support routing a first portion of data packets of the set of data packets via a first logical channel associated with a first priority, and routes a second portion of data packets of the set of data packets via a second logical channel associated with a second priority, where the set of logical channels includes the first logical channel and the second logical channel, and where the second priority is higher than the first priority. Additionally, or alternatively, to route the set of data packets, the UE 800 may be configured to support rerouting the second portion of data packets via the second logical channel based on the set of one or more parameters satisfying at least one threshold value.

Additionally, or alternatively, to route the set of data packets, the UE 800 may be configured to support routing the set of data packets via at least one of the first logical channel or the second logical channel based on the set of one or more parameters indicating for respective data packets of the set of data packets to be routed via the first logical channel or the second logical channel. Additionally, or alternatively, to route the second portion of data packets, the UE 800 may be configured to support duplicating the second portion of data packets of the set of data packets, where an original version of the second portion of data packets is routed via the first logical channel and a duplicated version of the second portion of data packets is routed via the second logical channel, receiving additional signaling that indicates the duplicated version of the second portion of data packets is successfully transmitted, and discarding, based on the additional signaling, the original version of the second portion of data packets. Additionally, or alternatively, the UE 800 may be configured to support transmitting additional signaling including at least one of a BSR, a DSR, or an SR that indicates the second portion of data packets are available for transmission.

Additionally, or alternatively, the UE 800 may be configured to support multiplexing the second portion of data packets on one or more resources associated with at least one of an uplink grant allocating the one or more resources for an uplink transmission or a CG allocating the one or more resources for the second logical channel. Additionally, or alternatively, the RLC configuration includes instructions for routing the set of data packets via respective logical channels of the set of logical channels based on the set of one or more parameters. Additionally, or alternatively, the UE 800 may be configured to support determining to route the set of data packets via respective logical channels of the set of logical channels based on metadata associated with the set of data packets, where the metadata indicates the set of one or more parameters.

Additionally, or alternatively, the UE 800 may be configured to support determining to route the set of data packets via respective logical channels of the set of logical channels based on additional signaling from a PDCP entity. Additionally, or alternatively, the RLC configuration includes a prioritized bit rate value, and a bucket size duration associated with the set of logical channels. Additionally, or alternatively, the UE 800 may be configured to support receiving additional signaling including an uplink grant that indicates one or more resources allocated for respective logical channels of the set of logical channels. Additionally, or alternatively, to route the set of data packets, the UE 800 may be configured to support routing sets of related data packets via respective logical channels of the set of logical channels. Additionally, or alternatively, the set of data packets includes a set of RLC PDUs.

Additionally, or alternatively, the UE 800 may support at least one memory (e.g., the memory 804) and at least one processor (e.g., the processor 802) coupled with the at least one memory and configured to cause the UE 800 to receive signaling that indicates an RLC configuration for a radio bearer associated with an RLC entity, where the RLC entity includes a set of logical channels and route a set of data packets via the set of logical channels based on a set of one or more parameters associated with at least one of the set of logical channels or the set of data packets.

Additionally, the UE 800 may be configured to or operable to support any one or combination of the set of one or more parameters include one or more of a priority associated with respective logical channels of the set of logical channels, a remaining delay associated with the set of data packets, a priority associated with respective data packets of the set of data packets, an importance level associated with the respective data packets of the set of data packets, or a type associated with the respective data packets. Additionally, or alternatively, to route the set of data packets, the at least one processor is configured to cause the UE 800 to route a first portion of data packets of the set of data packets via a first logical channel associated with a first priority, and route a second portion of data packets of the set of data packets via a second logical channel associated with a second priority, where the set of logical channels includes the first logical channel and the second logical channel, and where the second priority is higher than the first priority. Additionally, or alternatively, to route the set of data packets, the at least one processor is configured to cause the UE 800 to reroute the second portion of data packets via the second logical channel based on the set of one or more parameters satisfying at least one threshold value.

Additionally, or alternatively, to route the set of data packets, the at least one processor is configured to cause the UE 800 to route the set of data packets via at least one of the first logical channel or the second logical channel based on the set of one or more parameters indicating for respective data packets of the set of data packets to be routed via the first logical channel or the second logical channel. Additionally, or alternatively, to route the second portion of data packets, the at least one processor is configured to cause the UE 800 to duplicate the second portion of data packets of the set of data packets, where an original version of the second portion of data packets is routed via the first logical channel and a duplicated version of the second portion of data packets is routed via the second logical channel, receive additional signaling that indicates the duplicated version of the second portion of data packets is successfully transmitted, and discard, based on the additional signaling, the original version of the second portion of data packets. Additionally, or alternatively, the at least one processor is configured to cause the UE 800 to transmit additional signaling including at least one of a BSR, a DSR, or an SR that indicates the second portion of data packets are available for transmission.

Additionally, or alternatively, the at least one processor is configured to cause the UE 800 to multiplex the second portion of data packets on one or more resources associated with at least one of an uplink grant allocating the one or more resources for an uplink transmission or a CG allocating the one or more resources for the second logical channel. Additionally, or alternatively, the RLC configuration includes instructions for routing the set of data packets via respective logical channels of the set of logical channels based on the set of one or more parameters. Additionally, or alternatively, the at least one processor is configured to cause the UE 800 to determine to route the set of data packets via respective logical channels of the set of logical channels based on metadata associated with the set of data packets, where the metadata indicates the set of one or more parameters.

Additionally, or alternatively, the at least one processor is configured to cause the UE 800 to determine to route the set of data packets via respective logical channels of the set of logical channels based on additional signaling from a PDCP entity. Additionally, or alternatively, the RLC configuration includes a prioritized bit rate value, and a bucket size duration associated with the set of logical channels. Additionally, or alternatively, the at least one processor is configured to cause the UE 800 to receive additional signaling including an uplink grant that indicates one or more resources allocated for respective logical channels of the set of logical channels. Additionally, or alternatively, to route the set of data packets, the at least one processor is configured to cause the UE 800 to route sets of related data packets via respective logical channels of the set of logical channels. Additionally, or alternatively, the set of data packets includes a set of RLC PDUs.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

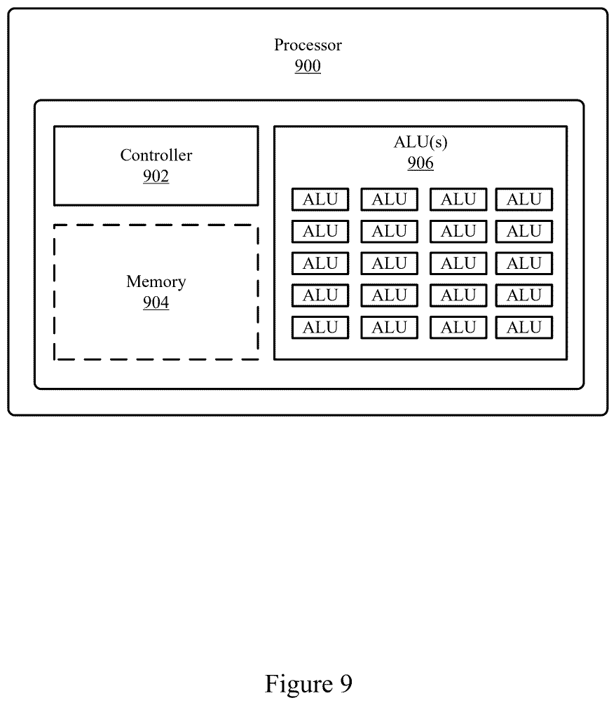

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to receive signaling that indicates an RLC configuration for a radio bearer associated with an RLC entity, where the RLC entity includes a set of logical channels and route a set of data packets via the set of logical channels based on a set of one or more parameters associated with at least one of the set of logical channels or the set of data packets.

Additionally, the processor 900 may be configured to or operable to support any one or combination of the set of one or more parameters include one or more of a priority associated with respective logical channels of the set of logical channels, a remaining delay associated with the set of data packets, a priority associated with respective data packets of the set of data packets, an importance level associated with the respective data packets of the set of data packets, or a type associated with the respective data packets. Additionally, or alternatively, to route the set of data packets, the at least one controller is configured to cause the processor 900 to route a first portion of data packets of the set of data packets via a first logical channel associated with a first priority, and route a second portion of data packets of the set of data packets via a second logical channel associated with a second priority, where the set of logical channels includes the first logical channel and the second logical channel, and where the second priority is higher than the first priority. Additionally, or alternatively, to route the set of data packets, the at least one controller is configured to cause the processor 900 to reroute the second portion of data packets via the second logical channel based on the set of one or more parameters satisfying at least one threshold value.

Additionally, or alternatively, to route the set of data packets, the at least one controller is configured to cause the processor 900 to route the set of data packets via at least one of the first logical channel or the second logical channel based on the set of one or more parameters indicating for respective data packets of the set of data packets to be routed via the first logical channel or the second logical channel. Additionally, or alternatively, to route the second portion of data packets, the at least one controller is configured to cause the processor 900 to duplicate the second portion of data packets of the set of data packets, where an original version of the second portion of data packets is routed via the first logical channel and a duplicated version of the second portion of data packets is routed via the second logical channel, receive additional signaling that indicates the duplicated version of the second portion of data packets is successfully transmitted, and discard, based on the additional signaling, the original version of the second portion of data packets. Additionally, or alternatively, the at least one controller is configured to cause the processor 900 to transmit additional signaling including at least one of a BSR, a DSR, or an SR that indicates the second portion of data packets are available for transmission.

Additionally, or alternatively, the at least one controller is configured to cause the processor 900 to multiplex the second portion of data packets on one or more resources associated with at least one of an uplink grant allocating the one or more resources for an uplink transmission or a CG allocating the one or more resources for the second logical channel. Additionally, or alternatively, the RLC configuration includes instructions for routing the set of data packets via respective logical channels of the set of logical channels based on the set of one or more parameters. Additionally, or alternatively, the at least one controller is configured to cause the processor 900 to determine to route the set of data packets via respective logical channels of the set of logical channels based on metadata associated with the set of data packets, where the metadata indicates the set of one or more parameters.

Additionally, or alternatively, the at least one controller is configured to cause the processor 900 to determine to route the set of data packets via respective logical channels of the set of logical channels based on additional signaling from a PDCP entity. Additionally, or alternatively, the RLC configuration includes a prioritized bit rate value, and a bucket size duration associated with the set of logical channels. Additionally, or alternatively, the at least one controller is configured to cause the processor 900 to receive additional signaling including an uplink grant that indicates one or more resources allocated for respective logical channels of the set of logical channels. Additionally, or alternatively, to route the set of data packets, the at least one controller is configured to cause the processor 900 to route sets of related data packets via respective logical channels of the set of logical channels. Additionally, or alternatively, the set of data packets includes a set of RLC PDUs.

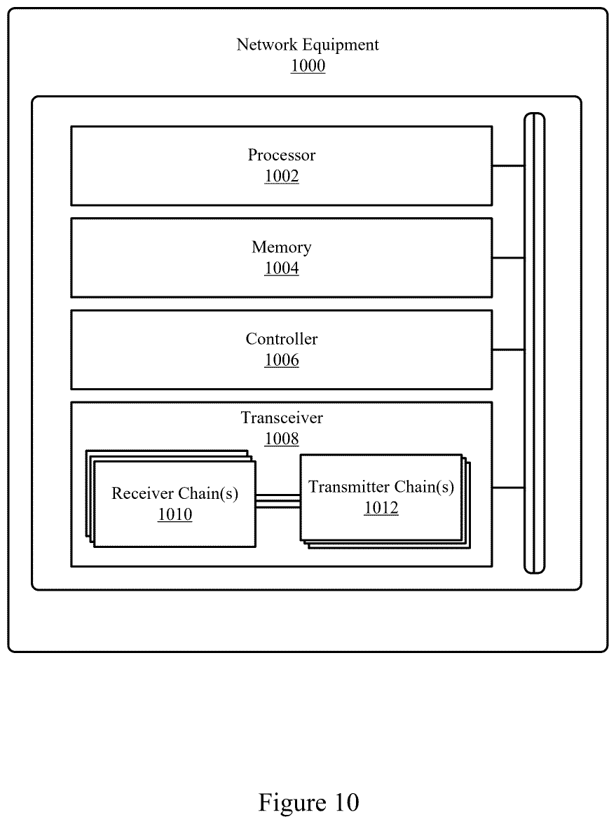

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to or operable to support a means for transmitting signaling that indicates an RLC configuration for a radio bearer associated with an RLC entity, where the RLC entity includes a set of logical channels, receiving a set of data packets via the set of logical channels, where a first portion of data packets of the set of data packets is routed via a first logical channel associated with a first priority and a second portion of data packets of the set of data packets is routed via a second logical channel associated with a second priority, the set of logical channels includes the first logical channel and the second logical channel, and the second priority is set to a value indicating a higher priority than the first priority, and disabling reordering of the second portion of data packets based on the second portion of data packets being routed via the second logical channel.

Additionally, the NE 1000 may be configured to or operable to support any one or combination of processing, at a higher layer, the second portion of data packets based on the reordering of the second portion of data packets being disabled. Additionally, or alternatively, the set of data packets are routed based on a set of one or more parameters associated with at least one of the set of logical channels or the set of data packets and the set of one or more parameters include one or more of a priority associated with respective logical channels of the set of logical channels, a remaining delay associated with the set of data packets, a priority associated with respective data packets of the set of data packets, an importance level associated with the respective data packets of the set of data packets, or a type associated with the respective data packets. Additionally, or alternatively, the NE 1000 may be configured to or operable to support transmitting additional signaling that indicates the second portion of data packets is successfully received.

Additionally, or alternatively, the NE 1000 may be configured to or operable to support receiving additional signaling including at least one of a BSR, a DSR, or an SR that indicates the second portion of data packets are available for transmission. Additionally, or alternatively, the second portion of data packets is multiplexed on one or more resources associated with at least one of an uplink grant allocating the one or more resources for an uplink transmission or a CG allocating the one or more resources for the second logical channel. Additionally, or alternatively, the RLC configuration includes instructions for routing the set of data packets via respective logical channels of the set of logical channels based on a set of one or more parameters. Additionally, or alternatively, the RLC configuration includes a prioritized bit rate value, and a bucket size duration associated with the set of logical channels. Additionally, or alternatively, the NE 1000 may be configured to or operable to support transmitting additional signaling including an uplink grant that indicates one or more resources allocated for respective logical channels of the set of logical channels. Additionally, or alternatively, the set of data packets includes a set of RLC PDUs.

Additionally, or alternatively, the NE 1000 may support at least one memory (e.g., the memory 1004) and at least one processor (e.g., the processor 1002) coupled with the at least one memory and configured to cause the NE to transmit signaling that indicates an RLC configuration for a radio bearer associated with an RLC entity, where the RLC entity includes a set of logical channels, receive a set of data packets via the set of logical channels, where a first portion of data packets of the set of data packets is routed via a first logical channel associated with a first priority and a second portion of data packets of the set of data packets is routed via a second logical channel associated with a second priority, the set of logical channels includes the first logical channel and the second logical channel, and the second priority is set to a value indicating a higher priority than the first priority, and disable reordering of the second portion of data packets based on the second portion of data packets being routed via the second logical channel.

Additionally, or alternatively, the at least one processor may be configured to cause the NE 1000 to process, at a higher layer, the second portion of data packets based on the reordering of the second portion of data packets being disabled. Additionally, or alternatively, the set of data packets are routed based on a set of one or more parameters associated with at least one of the set of logical channels or the set of data packets, and where the set of one or more parameters include one or more of a priority associated with respective logical channels of the set of logical channels, a remaining delay associated with the set of data packets, a priority associated with respective data packets of the set of data packets, an importance level associated with the respective data packets of the set of data packets, or a type associated with the respective data packets. Additionally, or alternatively, the at least one processor may be configured to cause the NE 1000 transmit additional signaling that indicates the second portion of data packets is successfully received.

Additionally, or alternatively, the at least one processor may be configured to cause the NE 1000 receive additional signaling including at least one of a BSR, a DSR, or an SR that indicates the second portion of data packets are available for transmission. Additionally, or alternatively, the second portion of data packets is multiplexed on one or more resources associated with at least one of an uplink grant allocating the one or more resources for an uplink transmission or a CG allocating the one or more resources for the second logical channel. Additionally, or alternatively, the RLC configuration includes instructions for routing the set of data packets via respective logical channels of the set of logical channels based on a set of one or more parameters. Additionally, or alternatively, the RLC configuration includes a prioritized bit rate value, and a bucket size duration associated with the set of logical channels. Additionally, or alternatively, the at least one processor may be configured to cause the NE 1000 transmit additional signaling including an uplink grant that indicates one or more resources allocated for respective logical channels of the set of logical channels. Additionally, or alternatively, the set of data packets includes a set of RLC PDUs.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

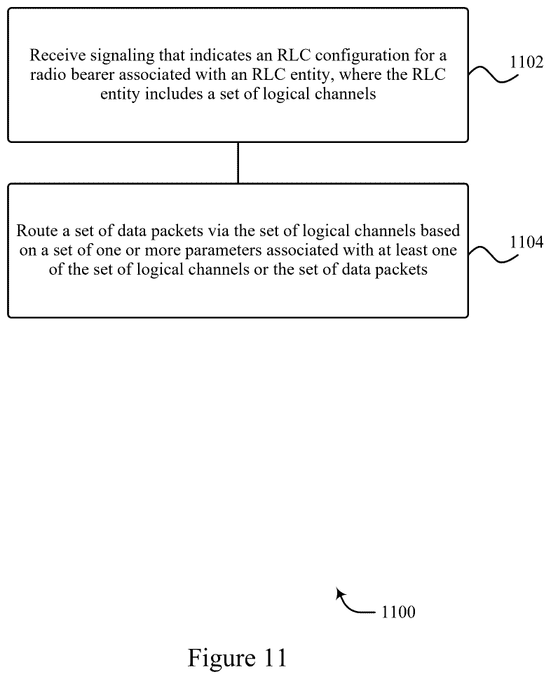

FIG. 11 illustrates a flowchart of a method 1100 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1102, the method may include receiving signaling that indicates an RLC configuration for a radio bearer associated with an RLC entity, where the RLC entity includes a set of logical channels. The operations of 1102 may be performed in accordance with examples as described herein. In some implementations, aspects of the operations of 1102 may be performed by a UE as described with reference to FIG. 8.

At 1104, the method may include routing a set of data packets via the set of logical channels based on a set of one or more parameters associated with at least one of the set of logical channels or the set of data packets. The operations of 1104 may be performed in accordance with examples as described herein. In some implementations, aspects of the operations of 1104 may be performed a UE as described with reference to FIG. 8.

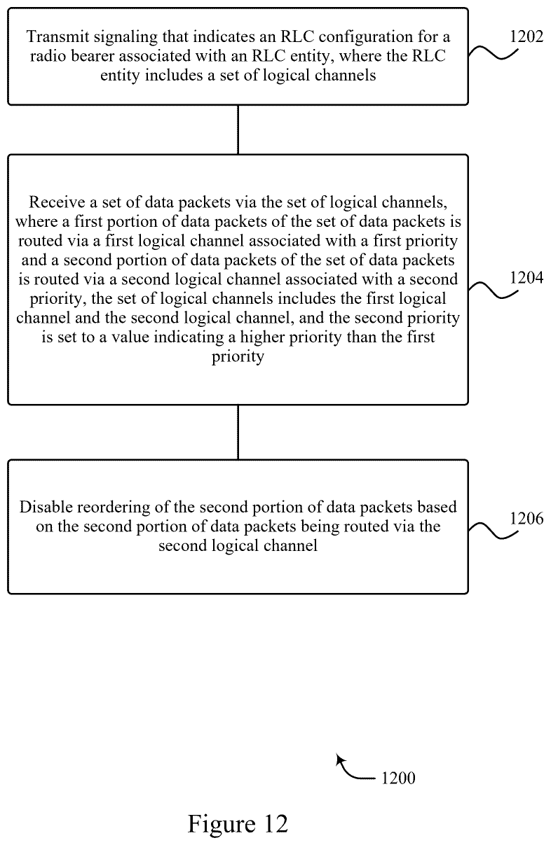

FIG. 12 illustrates a flowchart of a method 1200 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include transmitting signaling that indicates an RLC configuration for a radio bearer associated with an RLC entity, where the RLC entity includes a set of logical channels. The operations of 1202 may be performed in accordance with examples as described herein. In some implementations, aspects of the operations of 1202 may be performed by a NE as described with reference to FIG. 10.

At 1204, the method may include receiving a set of data packets via the set of logical channels, where a first portion of data packets of the set of data packets is routed via a first logical channel associated with a first priority and a second portion of data packets of the set of data packets is routed via a second logical channel associated with a second priority, the set of logical channels includes the first logical channel and the second logical channel, and the second priority is set to a value indicating a higher priority than the first priority. The operations of 1204 may be performed in accordance with examples as described herein. In some implementations, aspects of the operations of 1204 may be performed by a NE as described with reference to FIG. 10.

At 1206, the method may include disabling reordering of the second portion of data packets based on the second portion of data packets being routed via the second logical channel. The operations of 1206 may be performed in accordance with examples as described herein. In some implementations, aspects of the operations of 1206 may be performed a NE as described with reference to FIG. 10.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive signaling that indicates a radio link control (RLC) configuration for a radio bearer associated with an RLC entity, wherein the RLC entity comprises a plurality of logical channels; and
route a plurality of data packets via the plurality of logical channels based at least in part on a set of one or more parameters associated with at least one of the plurality of logical channels or the plurality of data packets.

2. The UE of claim 1, wherein the set of one or more parameters comprise one or more of a priority associated with respective logical channels of the plurality of logical channels, a remaining delay associated with the plurality of data packets, a priority associated with respective data packets of the plurality of data packets, an importance level associated with the respective data packets of the plurality of data packets, or a type associated with the respective data packets.

3. The UE of claim 1, wherein to route the plurality of data packets, the at least on processor is configured to cause the UE to:
route a first portion of data packets of the plurality of data packets via a first logical channel associated with a first priority; and
route a second portion of data packets of the plurality of data packets via a second logical channel associated with a second priority, wherein the plurality of logical channels comprises the first logical channel and the second logical channel, and wherein the second priority is higher than the first priority.

4. The UE of claim 3, wherein to route the plurality of data packets, the at least one processor is configured to cause the UE to reroute the second portion of data packets via the second logical channel based at least in part on the set of one or more parameters satisfying at least one threshold value.

5. The UE of claim 3, wherein to route the plurality of data packets, the at least one processor is configured to cause the UE to route the plurality of data packets via at least one of the first logical channel or the second logical channel based at least in part on the set of one or more parameters indicating for respective data packets of the plurality of data packets to be routed via the first logical channel or the second logical channel.

6. The UE of claim 3, wherein to route the second portion of data packets, the at least one processor is configured to cause the UE to:
duplicate the second portion of data packets of the plurality of data packets, wherein an original version of the second portion of data packets is routed via the first logical channel and a duplicated version of the second portion of data packets is routed via the second logical channel;
receive additional signaling that indicates the duplicated version of the second portion of data packets is successfully transmitted; and
discard, based at least in part on the additional signaling, the original version of the second portion of data packets.

7. The UE of claim 3, wherein the at least one processor is further configured to cause the UE to transmit additional signaling comprising at least one of a buffer status report (BSR), a delay status report (DSR), or a scheduling request (SR) that indicates the second portion of data packets are available for transmission.

8. The UE of claim 3, wherein the at least one processor is further configured to cause the UE to multiplex the second portion of data packets on one or more resources associated with at least one of an uplink grant allocating the one or more resources for an uplink transmission or a configured grant allocating the one or more resources for the second logical channel.

9. The UE of claim 1, wherein the RLC configuration comprises instructions for routing the plurality of data packets via respective logical channels of the plurality of logical channels based at least in part on the set of one or more parameters.

10. The UE of claim 1, wherein the at least one processor is further configured to cause the UE to determine to route the plurality of data packets via respective logical channels of the plurality of logical channels based at least in part on metadata associated with the plurality of data packets, wherein the metadata indicates the set of one or more parameters.

11. The UE of claim 1, wherein the at least one processor is further configured to cause the UE to determine to route the plurality of data packets via respective logical channels of the plurality of logical channels based at least in part on additional signaling from a packet data convergence protocol (PDCP) entity.

12. The UE of claim 1, wherein the RLC configuration comprises a prioritized bit rate value and a bucket size duration associated with the plurality of logical channels.

13. The UE of claim 1, wherein the at least one processor is further configured to cause the UE to receive additional signaling comprising an uplink grant that indicates one or more resources allocated for respective logical channels of the plurality of logical channels.

14. The UE of claim 1, wherein to route the plurality of data packets, the at least one processor is configured to cause the UE to route sets of related data packets via respective logical channels of the plurality of logical channels.

15. The UE of claim 1, wherein the plurality of data packets comprises a plurality of RLC protocol data units (PDUs).

16. A processor for wireless communication, comprising:
at least one controller coupled with at least one memory and configured to cause the processor to:
receive signaling that indicates a radio link control (RLC) configuration for a radio bearer associated with an RLC entity, wherein the RLC entity comprises a plurality of logical channels; and
route a plurality of data packets via the plurality of logical channels based at least in part on a set of one or more parameters associated with at least one of the plurality of logical channels or the plurality of data packets.

17. A method performed by a user equipment (UE), the method comprising:
receiving signaling that indicates a radio link control (RLC) configuration for a radio bearer associated with an RLC entity, wherein the RLC entity comprises a plurality of logical channels; and
routing a plurality of data packets via the plurality of logical channels based at least in part on a set of one or more parameters associated with at least one of the plurality of logical channels or the plurality of data packets.

18. A network equipment (NE) for wireless communication, comprising:
at least one memory; and
at least one processor coupled with the at least one memory and configured to cause the NE to:
transmit signaling that indicates a radio link control (RLC) configuration for a radio bearer associated with an RLC entity, wherein the RLC entity comprises a plurality of logical channels;
receive a plurality of data packets via the plurality of logical channels, wherein:
a first portion of data packets of the plurality of data packets is routed via a first logical channel associated with a first priority and a second portion of data packets of the plurality of data packets is routed via a second logical channel associated with a second priority;
the plurality of logical channels comprises the first logical channel and the second logical channel; and
the second priority is set to a value indicating a higher priority than the first priority; and
disabling reordering of the second portion of data packets based at least in part on the second portion of data packets being routed via the second logical channel.

19. The NE of claim 18, wherein the at least one processor is further configured to cause the NE to process, at a higher layer, the second portion of data packets based at least in part on the reordering of the second portion of data packets being disabling.

20. The NE of claim 18, wherein the plurality of data packets are routed based at least in part on a set of one or more parameters associated with at least one of the plurality of logical channels or the plurality of data packets, and wherein the set of one or more parameters comprise one or more of a priority associated with respective logical channels of the plurality of logical channels, a remaining delay associated with the plurality of data packets, a priority associated with respective data packets of the plurality of data packets, an importance level associated with the respective data packets of the plurality of data packets, or a type associated with the respective data packets.
